(19) United States
(12) Patent Application Publication
(10) Pub. No.: US 2006/0020552 A1
(43) Pub. Date: Jan. 26, 2006

(54) Copy-restriction system for digitally recorded, computer disk-based music recordings

(76) Inventors: James Sloan, Waco, TX (US); Ruthie Sloan, Arlington, TX (US); Richard Dixon, Waco, TX (US)

Correspondence Address: David G. Henry;4100, 900 Washington Avenue, P.O. Box 1470, Waco, TX, 76703-1470, US

(21) Appl. No.: 10/899,271

(22) Filed: Jul. 26, 2004

(51) Int. Cl. G06F 17/60

(52) U.S. Cl. 705/57

(57) ABSTRACT

A software routine, method of use of such software routine, and associated business method for the distribution of piracy-resistant audio recordings via digital recording media.

### BACKGROUND OF THE INVENTION

1. Field of the Invention

The present invention relates to computer-based processes and to digitally recorded music and methods for preventing or hindering the illegal duplicate.

2. Background Information

Piracy of recorded music is a well-known and recently much more publicized problem. Profits of recording artists and record companies have suffered markedly, particularly since the combination of CD-based recordings, MP3 files, and the internet has made it quite easy for one individual, with one CD to illegally distribute countless copies of music recordings. Each copy delivered to a “consumer” of illegal music copies has the almost certain effect of eliminating a legitimate sale of an original CD.

A conventional CD music recording can be somewhat easily copied using a variety of readily available software products with “ripping” functions. Even easier to duplicate and disseminate are MP3 files, because they, like any other Windows-based computer files can readily be moved, copied, deleted, etc. using Windows edit commands. The MP3 format is the common currency of music pirates in illegally copying and disseminating copied musical works via the internet or recorded disks. This is because of their compact size and easy duplication and dissemination.

The recent torrent of lawsuits by the recording industry in the United States, designed to quell music pirates through intimidation, are believed by some experts to be of very limited practical effect. Most music pirates appear willing to simply “play the odds” and continue their illegal downloading and copying of copyrighted music.

The present trends of music piracy threaten the very existence of viable music artistry and music distribution systems—embodiments of the arts for which the Founding Fathers themselves viewed as sufficiently important to provide protection in the United States Constitution.

Returning to vinyl phonograph records as a music dissemination medium is not realistic approach to the described threat. Therefore, some method or device which at least significantly curbs illegal copying must be put into place, if the music industry as we know it is to survive.

### SUMMARY OF THE INVENTION

In view of the foregoing (and understanding that any reference to “Windows” herein is intended to include reference, as logically applicable, to computer operating system counterparts, including, but not limited to, the MCINTOSH operating system) it is an object of the present invention to provide a method for hindering the duplication of digitally recorded, computer disk-based music (or other audio) recordings.

It is another object of the present invention to provide a music distribution method which, by use of prescribed data file types, together with complimentary software, renders such files' duplication very difficult, if not impossible.

It is another object of the present invention to provide an executable software routine which, when executed by a Windows-based computer operating system, deactivates edit commands which facilitate the duplication of files residing on the same disk as such software routine.

In satisfaction of these and other related objectives, Applicant's present invention provides a software routine, method of use of such software routine, and associated business method for the distribution of piracy-resistant audio recordings. According to the present business method, digital audio recordings are disseminated commercially on CDs, as they conventionally are now, but are disseminated in MP3 or other file formats which are manipulatable by Windows operating system edit commands. The CDs may also be disseminated with conventional music CD files which may be played on music CD players (as opposed to computer-based CD readers).

The primary key to piracy prevention according to the present invention is that, when the CD is placed in a computer-based CD reader, the executable software routine of the present invention is automatically “run” by the computer. This software routine carries out several important functions, the likely most important of which is the disabling of the Windows edit commands (“Copy”, “Paste”, “Move”, etc.). Additionally, however, at least an audio, and perhaps an audio/video file plays before the recorded music. This file reproduces speech (and possibly video) of the recording artist(s) imploring the listener or viewer not to illegally copy the product of their labor and thereby steal their livelihood (or words to that effect). Furthermore, the software routine includes a “digital fingerprint” which follows any whole-disk copies of the CD. Finally, preferred embodiments of the present invention will include a Windows-based MP3 player, with only “Play” and track selection-related soft keys, and which is automatically executed (in lieu of any other such player with possible duplication features) upon insertion of the subject CD.

It is believed that practice of the present invention can impede the illegal diversion of millions of dollars of revenues for recording artists and music distribution entities.

The present inventors' approach to the problem described may appear relatively simple in retrospect, but it is equally unobvious, and made abundantly clear by the magnitude of the largely unaddressed problem and consequences.

### DETAILED DESCRIPTION OF THE PREFERRED EMBODIMENT

The discussion of features and embodiments or practice modes of the present invention appearing above are incorporated here by reference.

Referring to Appendix A to this disclosure, exemplary software code for carrying out the stated operations is presented.

It should be understood that the presented code is merely one embodiment of the process of the present invention. The same functions and resulting operations could well be carried out using other programming language, program structure, or even intended operating system.

As will be apparent to anyone reasonably skilled in the computer programming and operations art, the example software regimens provide the features and carries out the functions described above. Several references to DVDs appear in the comments. These illustrates that the present anti-piracy approach is equally applicable to “CDs” per se as well as to DVDs and other disk or analogous recording mediums (“mini disks”, for example) as may yet arise.

The software regimens are automatically executed upon insertion into a computer-based CD reader, whereas they are essentially “invisible” to a conventional music CD player which lacks threatening copy features and is of not apparent threat.

When “playing” the CD with a computer-based CD reader, the software routines execute and the operating system edit commands are “greyed out”, thereby rendering them useless of moving or copying the resident media files (the MP3 or analogous data files which include the to-be-protected music or other audio).

Also, the above-described anti-piracy appeal or warning is played for the listener (or viewer) . This data file may be MP3 or equivalent files for audio, or MPEG or equivalent files for audio and video. Alternatively, an MP3 or equivalent file may be used for the recorded voice warning or appeal, while a graphics file (.jpg, .tif, .bmp, etc.) may show a still shot of the artist(s).

In preferred embodiments of the present invention, the resident MP3 player (or analogous DVD media files player) will open, with its limited play and track selection soft keys (and optionally a “pause” button).

Finally, an embedded tracking number, unique to the individual disk copy, is added to the computers register, and follows any copy of files or of the entire disk as may somehow be made by the user.

The business method of the present invention involves disseminating audio works (or analogous audio/video works) via computer disk media and, at least in part, in file format(s), the copying or moving of which are dependant on computer operating system edit commands. The disks include computer-executable files which run upon interface with any computer-based CD reader. The software routines, at a minimum, temporarily disable the computer operating system's edit commands. In the case of Windows operating systems, for example, opening Windows Explorer will reveal that “Copy”, “Move”, and “Paste” are all “greyed out” and will not actuate.

Additional features of the present method have already been described and, in any preferred mode of the present invention, will be included in practice of the present invention.

Although the invention has been described with reference to specific embodiments, this description is not meant to be construed in a limited sense. Various modifications of the disclosed embodiments, as well as alternative embodiments of the inventions will become apparent to persons skilled in the art upon reference to the description of the invention. It is, therefore, contemplated that the appended claims will cover such modifications that fall within the scope of the invention.

I claim:

1. A process for inhibiting computer file duplication comprising the steps of:
recording data files on recordable media;
recording software routines on said recordable media, which software routines, without user initiation, execute upon interface with a compatible computer system and disables edit commands of the operating system of said compatible computer system.

2. The process of claim 1 wherein said data files are audio files.

3. The process of claim 1 wherein said data files are audio/visual files.

4. The process of claim 1 wherein said recordable media are compact disks.

5. The process of claim 2 wherein said recordable media are compact disks.

6. The process of claim 3 wherein said recordable media are compact disks.

7. The process of claim 1 wherein said software routines further cause the execution of an media file which includes a user-perceptible message pertaining to the illegality of copyright violations.

8. The process of claim 6 wherein said message includes a representation of the author of the work or works embodied in said data files.

9. A business method for the distribution of piracy-resistant works in digital form comprising the steps of:
recording data files on recordable media, said data files embodying proprietary works;
recording software routines on said recordable media, which software routines, without user initiation, execute upon interface with a compatible computer system and disables edit commands of the operating system of said compatible computer system; and
commercially distributing said recordable media to purchasers.

10. The method of claim 8 wherein said data files are audio files.

11. The method of claim 8 wherein said data files are audio/visual files.

12. The method of claim 8 wherein said recordable media are compact disks.

13. The method of claim 9 wherein said recordable media are compact disks.

14. The method of claim 10 wherein said recordable media are compact disks.

15. The method of claim 8 wherein said software routines further cause the execution of an media file which includes a user-perceptible message pertaining to the illegality of copyright violations.

16. The method of claim 14 wherein said message includes a representation of the author of the work or works embodied in said data files.

17. A computer software routine comprising computer-executable commands which, when recorded on removable computer readable media, and without user initiation, execute upon interface with a compatible computer system and disables edit commands of the operating system of said compatible computer system.
